(19) United States
(12) Patent Application Publication
(10) Pub. No.: US 2007/0226089 A1
(43) Pub. Date: Sep. 27, 2007

(54) System and method for distributing building materials in a controlled manner

(76) Inventors: Stephen DeGaray, Huntington, NY (US); Peter Larsen, Farum (DK)

Correspondence Address: WILLIAM COLLARD;COLLARD & ROE, P.C., 1077 NORTHERN BOULEVARD, ROSLYN, NY, 11576, US

(21) Appl. No.: 11/726,011

(22) Filed: Mar. 20, 2007

Related U.S. Application Data
(60) Provisional application No. 60/743,716, filed on Mar. 23, 2006.

(51) Int. Cl. B28C 5/10

(52) U.S. Cl. 705/28; 705/400; 366/33; 366/50

(57) ABSTRACT

The disclosure relates to a portable system for distributing building materials comprising a motor vehicle which can be in the form of a truck. Disposed on a flat bed of the truck is at least one container coupled to the motor vehicle. The container can include at least one stirrer wherein the stirrer is for stirring a first component in the container. There can be at least one mixer coupled to the motor vehicle wherein the mixer is for mixing at least one liquid component with the component in the container to form a slurry. Once the slurry is formed, it can be fed to at least one distribution feeder which is then used to feed materials to a job site. This system can include a computer for controlling the mixer, and the distribution feeder to control the distribution of this slurry material. The disclosure can also relate to a process for creating the dry mixture, the slurry and then distributing this slurry so as to create a building component such as a floor. This process can be monitored by a computer, wherein the computer can be used to generate a series of reports such as a job report, a quality control report or a bill.

### CROSS REFERENCE TO RELATED APPLICATIONS

This application is a non-provisional application and hereby claims priority from provisional application Ser. No. 60/743,716 filed on Mar. 23, 2006, titled “A SYSTEM AND METHOD FOR DISTRIBUTING BUILDING MATERIALS IN A CONTROLLED MANNER”, wherein the disclosure of this application is hereby incorporated herein by reference in its entirety.

### BACKGROUND OF THE INVENTION

The invention relates to a system and process for transporting a distribution unit on a motor vehicle and for distributing building materials in a controlled manner.

### SUMMARY OF THE INVENTION

One embodiment of the invention relates to a process for creating a flooring material. This process includes a series of steps such as providing at least one building component distribution system on a flatbed of a motor vehicle, moving the motor vehicle to a job site, stirring a first set of components in a silo, stirring a second set of components in a silo, and then mixing the first set of components with the second set of components to create a dry mixture. Next once the dry mixture is created this mixture is then mixed with a liquid such as water to create a slurry mixture. The process for the creation of the mixture and the slurry is monitored via a computer controlled process. Next, this mixture is distributed to create a building component such as a floor.

The invention can also include a portable system for distributing building materials comprising a motor vehicle which can be in the form of a truck. Disposed on a flat bed of the truck is at least one container coupled to the motor vehicle. The container can include at least one stirrer wherein the stirrer is for stirring a first component in the container. There can be at least one mixer coupled to the motor vehicle wherein the mixer is for mixing at least one liquid component with the component in the container to form a slurry. Once the slurry is formed, it can be fed to at least one distribution feeder which is then used to feed materials to a job site. This system can include a computer for controlling the mixer, and the distribution feeder to control the distribution of this slurry material.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a side cross sectional view of a first embodiment;

FIG. 2A is a side view of the device shown in FIG. 1;

FIG. 2B is a top view of the device without hatch covers covering the openings;

FIG. 3 is a top view of the device;

FIG. 4 is a side view of the hydraulic arm;

FIG. 5A is a side view of a silo;

FIG. 5B is a bottom view of a silo;

FIG. 6A is a side view of a mixer;

FIG. 6B is an end view of a mixer;

FIG. 6C is a top view of a mixer;

FIG. 7A is an end view of the feeders;

FIG. 7B is a top view of the feeders;

FIG. 8 is a schematic diagram of the water system for the truck;

FIG. 9 is a schematic block diagram showing the communication between different devices on a truck;

FIG. 10 is a schematic block diagram showing the control panel in communication with the different components that are controlled by the control panel;

FIG. 11A is a flow chart showing the entire process for monitoring, distributing and reporting on the distribution of bulk materials;

FIG. 11B is another process for dispensing the building material;

FIG. 12 is a screen shot of a universal reporting screen;

FIG. 13A is a first section which can be found on the reporting screen shown in FIG. 12;

FIG. 13B is a second section which can be found on the reporting screen shown in FIG. 12;

FIG. 13C is a third section which can be found on the reporting screen shown in FIG. 12;

FIG. 13D is a fourth section which can be found on the reporting screen shown in FIG. 12;

FIG. 13E is a fifth section which can be found on the reporting screen shown in FIG. 12;

FIG. 13F is a sixth section which can be found on the reporting screen shown in FIG. 12;

FIG. 13G is a seventh section which can be found on the reporting screen shown in FIG. 12;

FIG. 13H is an eighth section which can be found on the reporting screen shown in FIG. 12;

FIG. 13I is a ninth section which can be found on the reporting screen shown in FIG. 12;

FIG. J is a tenth section which can be found on the reporting screen shown in FIG. 12;

FIG. 14 is a screen showing the listing of recipes for the mix;

FIG. 15A is a first screen for modifying these recipes;

FIG. 15B is a second screen for modifying these recipes;

FIG. 16A is a first screen for modifying the amount of water input into the system;

FIG. 16B is a second screen for modifying the amount of water input into the system;

FIG. 17A is a first screen for adjusting the screw speed and the vibration time in a silo;

FIG. 17B is a second screen for adjusting the screw speed and the vibration time in a silo;

FIG. 18A is a first screen showing the different adjustable screens for setting a capacity of a mixer;

FIG. 18B is a second screen for setting the capacity of a mixer;

FIG. 19A is a first screen for allowing a user to modify a job report;

FIG. 19B is a second screen for allowing a user to modify a job report;

FIG. 20 is a further job report modification screen;

FIG. 21 is a screen showing a finalized job report;

FIG. 22 is a screen showing a quality control report; and

FIG. 23 is a screen showing an embodiment of a single silo truck.

### DETAILED DESCRIPTION OF PREFERRED EMBODIMENTS

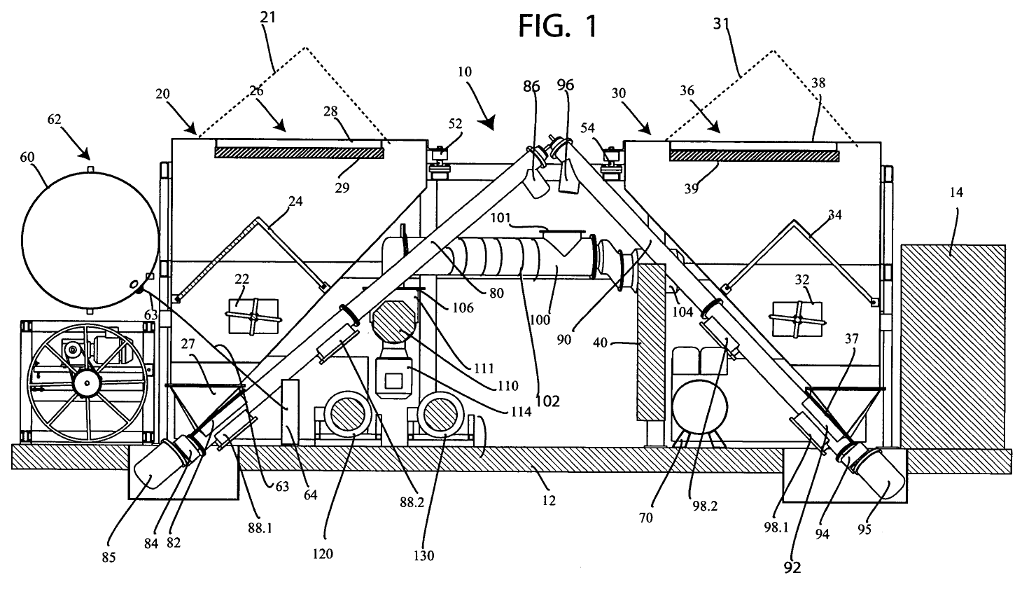

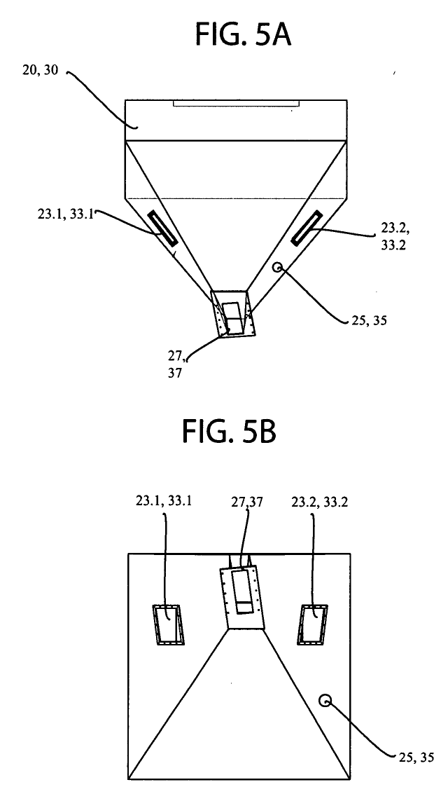

FIG. 1 discloses a side view of device 10 which includes a platform 12 which can be disposed on top of a flatbed of a truck. For example, a tractor-trailer could be adapted to have this device disposed on top of it. In this case, device 10 including all of the components shown in FIG. 1 would be disposed inside of a housing on top of this flatbed truck. Device 10 includes a generator 14 which is used to power all of the components on this platform 12. Device 10 also includes binder silo 20 which is for storing gypsum or other binder material. In addition, disposed inside of binder silo 20 is a binder stirrer 22. Binder stirrer 22 is for continuously stirring the binder inside of binder silo 20. In addition, other elements can also be used to continuously stir binder inside of this silo. For example, there can be vibration elements 23.1 and 23.2 (See FIGS. 5A and 5B). Furthermore, an air feed 25 can be used to stir this binder inside of binder silo 20.

By continuously stirring the gypsum or other binder material inside of this silo, the movement of the gypsum keeps the gypsum from forming aggregate components such as rocks or other bound material which could then jam paddles or screws that would be used to mix this component.

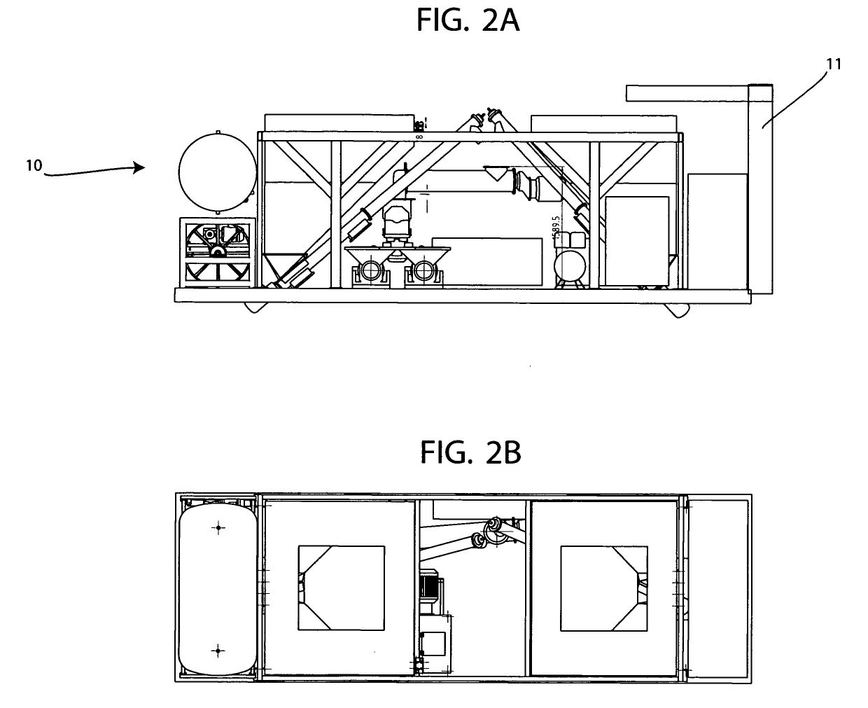

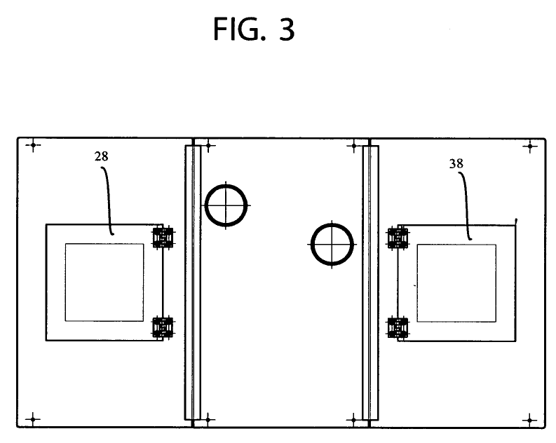

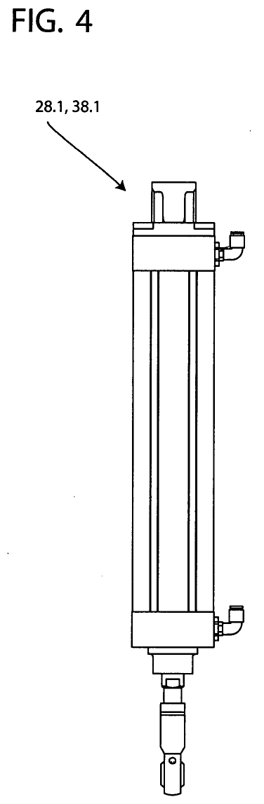

Gypsum or other materials can be fed into binder silo 20 by first being carried by a crane 11 (See FIG. 2A) and then cut open via a cutter, and then dumped into an opening 26 which is disposed at the top of binder silo 20. There is also a bottom opening 27 which can then be used to feed in the components into other sections such as column 80. Top opening 26 can have a hatch 28 coupled thereto see FIG. 3. In addition, a hydraulic piston 28.1 as shown in FIG. 4 can be used to selectively raise or lower hatch 28 to open this hatch.

A screen 29 is disposed at the top of binder silo 20, wherein the screen is designed to prevent any large aggregate from flowing into the silo. In addition, to aid in the spreading of gypsum, binder, or any other components inserted into this device, there is a spreader or deflector 29.1 disposed in binder silo 20. Thus, when bags of binder are cut open with cutter 21, binder can then be dumped through screen 29 into binder silo 20 where to send stirred and then distributed into column 80.

Accordingly, there is also a sand silo 30, wherein sand silo 30 includes a cutter 31 for cutting open bags of sand or other filler material which is to be inserted into sand silo 30. Sand silo 30 is constructed similar to binder silo 20. For example there is a sand stirrer 32, vibrating elements 33.1 and 33.2, (See FIGS. 5A and 5B) sand spreader 34, air feed 35, top opening 36, bottom opening 37, hatch 38, hydraulic piston 38.1 and screen 39. These elements function in a similar or substantially identical manner to the corresponding elements in binder silo 20.

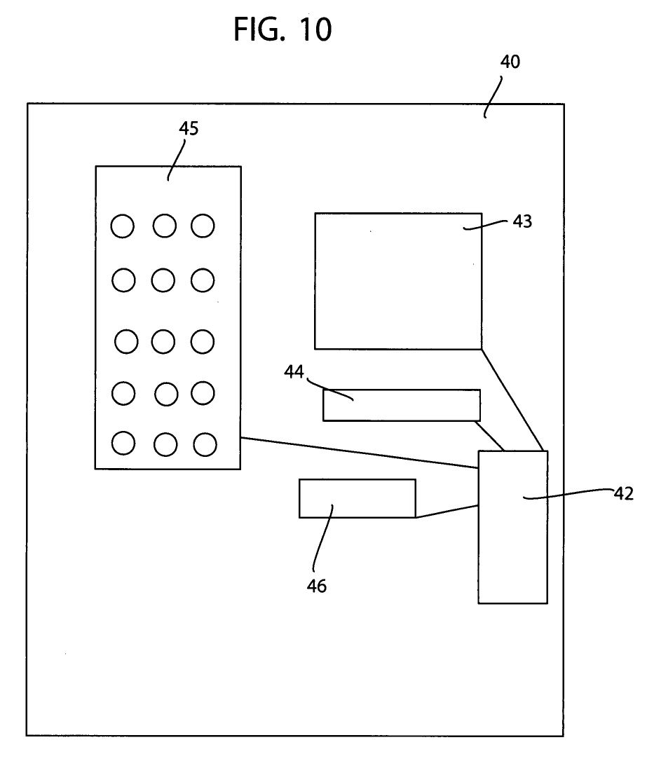

Controlling the actions or movement of all of these elements is a central computer which is housed in a control panel 40. Control panel 40 is disposed on platform 12 and can include a series of dials or switches and a central computer 42 (See FIG. 10).

For monitoring purposes, each of binder silo 20 and sand silo 30 is connected to a corresponding weight scale, such as a weight scale 52, or weight scale 54. For example, weight scale 52 is coupled to binder spreader 20 is used to weigh the components inside of binder silo 20. Weight scale 54 is coupled to sand silo 20 and is used to weigh the components such as sand inside of sand silo 20.

These weight scales are electrically and/or communicatively coupled to control panel 40 and are designed to feed information to the central computer 42 (See FIG. 10) disposed in control panel 40. Thus, the system has continuous information about the amount of material disposed in the silos, as well as the amount of material being distributed from the silos.

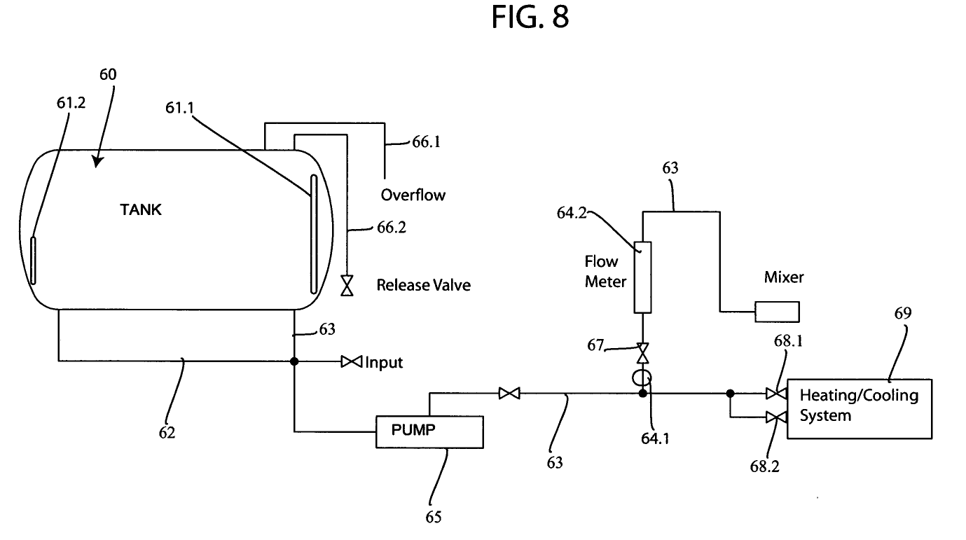

Disposed on platform 12 is a water tank 60. Water tank 60 has a plurality of sensors such as a level sensor 61.1 and a heat or temperature sensor 61.2 (See FIG. 8). Both of these sensors are in communication with computer 42 in control panel 40. Water tank 60 has a plurality of tubes 62 and 63, wherein tube 62 is for water input, while tube 63 is for water output into mixer 110. Water flowing from tubes 63 flows into volume meter 64.1 and then into flowmeter 64.2 (See FIG. 8) wherein both components are controlled by control panel 40. Volume meter 64.1 reads the volume of water flowing from water tank 60 while flowmeter 64.2 controls the flow of water into mixer 110.

Disposed on an opposite side from water tank 60 is an air compressor 70. Air compressor 70 is for providing air pressure to silos 20 and 30. Air compressor 70 provides high pressure air for moving either binder or sand inside of the silos.

In addition, there can be a plurality of columns, such as columns 80 and 90. Column 80 includes an input 82 which is in the form of an opening for receiving material output from binder silo 20. For example, material flows from binder silo 20 through bottom opening 27 via a gravity feed and into input 82. The flow of this material is controlled by a screw feeder 84. Screw feeder 84 is controlled by a screw motor 85, and is disposed inside of column 80. The screw feeder rotates and continuously pushes this binder material up through column 80 and through output 86. To prevent this column 80 from becoming clogged, a plurality of traps such as trap 88.1 or trap 88.2 are positioned along column 80 to allow easy access by user to remove any debris.

Another column 90 has similar components. For example, column 90 includes an input 92 which is in the form of an opening for receiving material output from sand silo 30. In this case, sand flows through bottom opening 37 via gravity feed and into input 92. The flow of this material is accordingly controlled by a screw feeder 94. Screw feeder 94 is controlled by a screw motor 95, wherein this screw motor at 95 is controlled by a control panel 40. This screw feeder 94 rotates continuously and pushes the same material up through column 90 and through output 96. In this case, to prevent column 90 from becoming clogged, a plurality of traps such as trap 98.1 or trap 98.2 are positioned along column 90 to allow easy access by a user remove any debris.

Once this material flows out of these columns, it flows into pre-mixer 100. Pre-mixer 100 is positioned below outputs 86 and 96. In this case, pre-mixer 100 includes an opening 101 for allowing a gravity feed of material into this mixer. Pre-mixer 100 includes a mixing element 102 disposed therein, wherein this mixing element includes a screw or angled paddle for mixing both the sand and binder or gypsum together. For example, coupled to pre-mixer 100 is a motor 104 for driving mixing element 102. Motor 104 is in communication with control panel 40, and is controlled by control panel 40 which regulates the speed of light is a screw or mixing paddles. This pre-mixer 100 includes a distribution end 106 for allowing this mixed material to flow out of this pre-mixer. This distribution end 106 is essentially an opening in the bottom of this pre-mixer which allows mixed material to flow via gravity into an opening for full mixer 110.

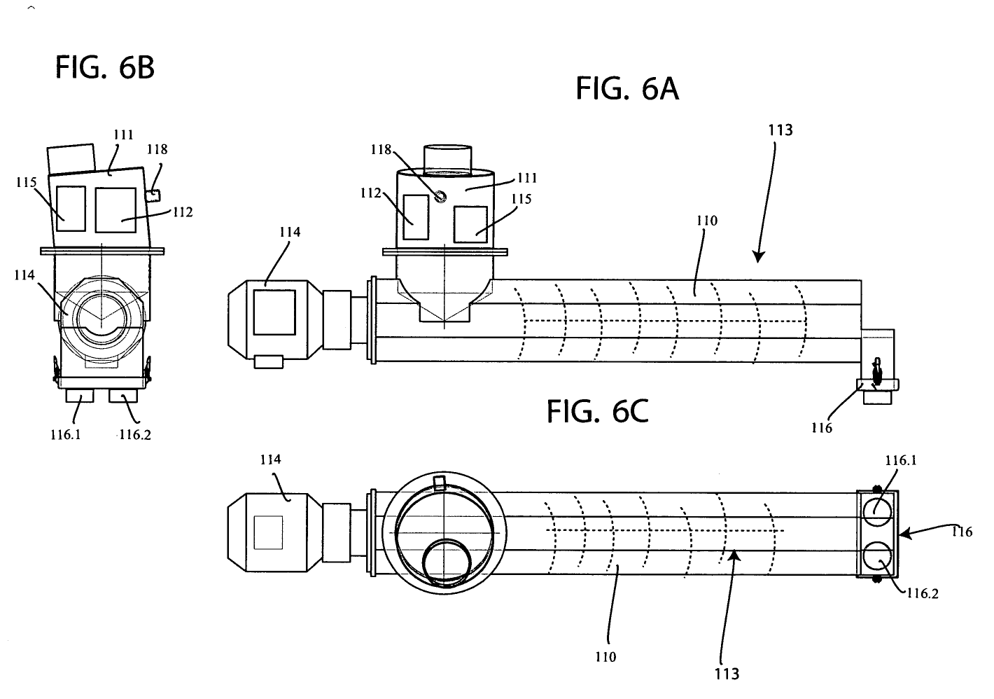

Full mixer 110 is shown in greater detail in FIGS. 6A, 6B and 6C. This device includes a hat 111 which has a mixing element 112 disposed therein. In this case, mixing element 112 can be in the form of a screw or angled paddle to selectively mix material as it is being entered into mixer 110. In addition, an additional mixing element 113 is disposed inside of the full mixer 110. Mixing element 113 is in the form of a screw or angled paddle which can be turned and driven by motor 114. As this screw or angled paddle 113 rotates, it mixes water, binder or gypsum, and sand together to create an aggregate or mixed component which can then be used to create solid materials such as floors, walls, etc.

Mixer 110 includes a high-low sensor 115 disposed inside of hat 111. High-low sensor 115 is in communication with control panel 40 such that if control panel 40 receives instructions from high-low sensor 115 that either too much or too little material is being entered into mixer 110, then control panel 40 can either increase the amount of material being inserted therein, or decrease the amount of material being inserted therein.

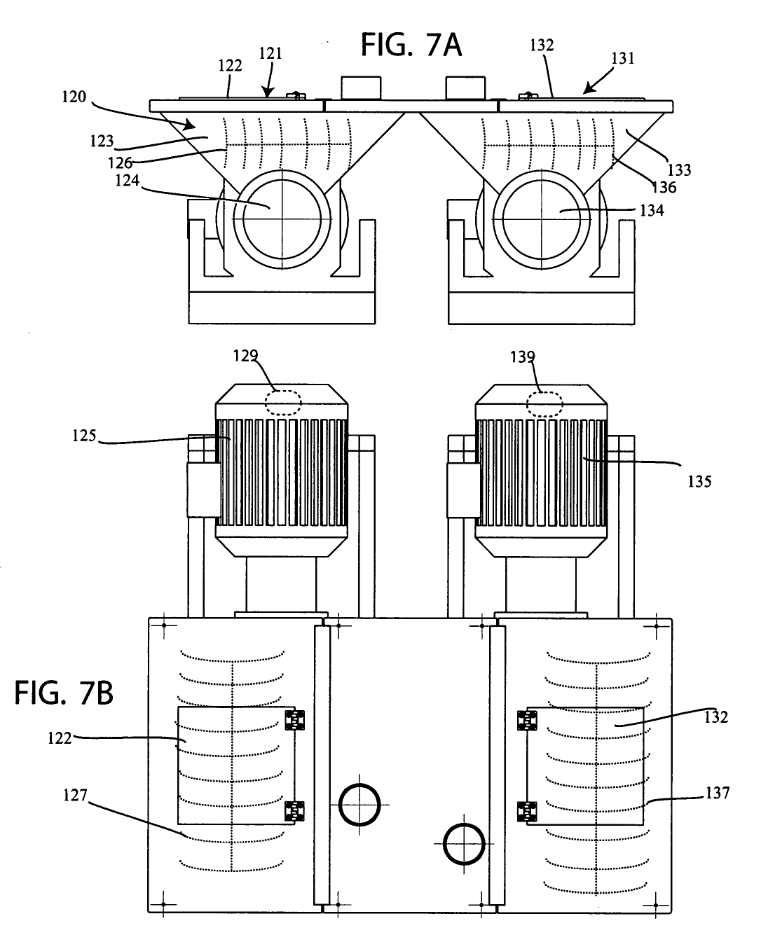

As material is being mixed inside of mixer 110, it is being pushed forward by either a screw or angled paddles which form the mixing element 113. This material is then pushed an output through output 116. In addition, water is added to mixer 110 via a water feed 118. Water feed 118 is fed from flowmeter 64.2 (See FIG. 8). In this case, mixer 110 feeds the mixed solution from outputs 116.1 and 116.2 into first feeder 120 and second feeder 130 respectively (See FIGS. 7A, 7B, and 7C).

First feeder or distributor 120 includes an opening 121 for receiving material fed from output 116.1. Opening 121 has a hatch 122 covering this opening. When hatch 122 is open, it creates an opening for receiving material into a settling bin 123. Settling bin 123 is disposed above the body of this device, and continuously feeds into the body of this device. This device has an output or opening 124 which is connectable to feeding hoses. Connected at an opposite end from opening 124 is a motor 125 which is used to drive both the mixing element 126, and screw feeder 127. Mixing element 126 can be in the form of a screw or angled paddle disposed in settling bin 123. Screw feeder 127 is disposed along the body of this device, and adjacent to output 124.

In addition, a substantially identical second feeder 130 is disposed adjacent to feeder 120. In this case, feeder 130 is formed as a second feeder and includes an opening 131 which can be selectively covered by a hatch 132. When hatch 132 is open, it allows material to enter into settling bin 133. This material can then leave this feeder 130 via output 134. A motor 135 is coupled to second feeder 130 and is used to drive a mixing element 136 disposed in settling bin 133 as well as a screw 137 disposed adjacent to opening 134. Screw 137 is for driving material outside of opening 131 and into associated hoses. Both feeders 120 and 130 have associated magnetic brakes 129 and 139 wherein each brake is associated with motors 125 and 135. Magnetic brakes 129 and 139 are designed to stop the rotation of screws 127 and 137 once they are no longer powered so that any head pressure in the associated hoses does not force material back into each of these feeders and result in material flowing out from these associated hats 123 and 133.

FIG. 8 discloses a schematic block diagram of the water system for the device. For example, in this view, there is a water tank 60 which can be disposed on platform 12. Water tank 60 includes an input line 62, and an output line 63. In this case, output line 63 feeds into pump 65 where the pressure flowing from output line 63 is then pumped to a higher pressure level and wherein this water is fed into either volume meter 64.1 and then flowmeter 64.2 through a shutoff valve 67, or into a heating and cooling system 69 via valves 68.1 and 68.2. Water flowing through valve 68.1 will flow into the heating system while water flowing through valve 68.2 would flow into the cooling system. The heating and cooling system 69 is used to regulate the temperature of the water flowing into the mix. Water flowing through flowmeter 64.2 then flows into a mixer such as mixer 110. Volume meter 64.1 and flowmeter 64.2 are both in communication with control panel 40. For example volume meter 64.1 sends information to control panel 40 to inform control panel 40 of the amount of water that has flowed past this meter. Flowmeter 64.2 sends information to control panel 40 about the flow of water flows from flowmeter 64.2. When the water flowing through flowmeter 64.2 is too high in volume as determined by control panel 40, then a program running on a computer in control panel 40 can reduce the amount of water flowing through this flowmeter. Alternatively, if the program in the control panel 40 determines that the water flowing through flowmeter 64.2 is too low then, the program running in control panel 40 can signal to pump 65 to increase the flow through flowmeter 64.2, or open any valve that may be constraining the flow of water through the system.

In this case, there are also additional lines and 66.1 and 66.2, wherein line 66.1 is an overflow line while line 66.2 flows through an optional release valve which allows additional water to flow out of tank 60.

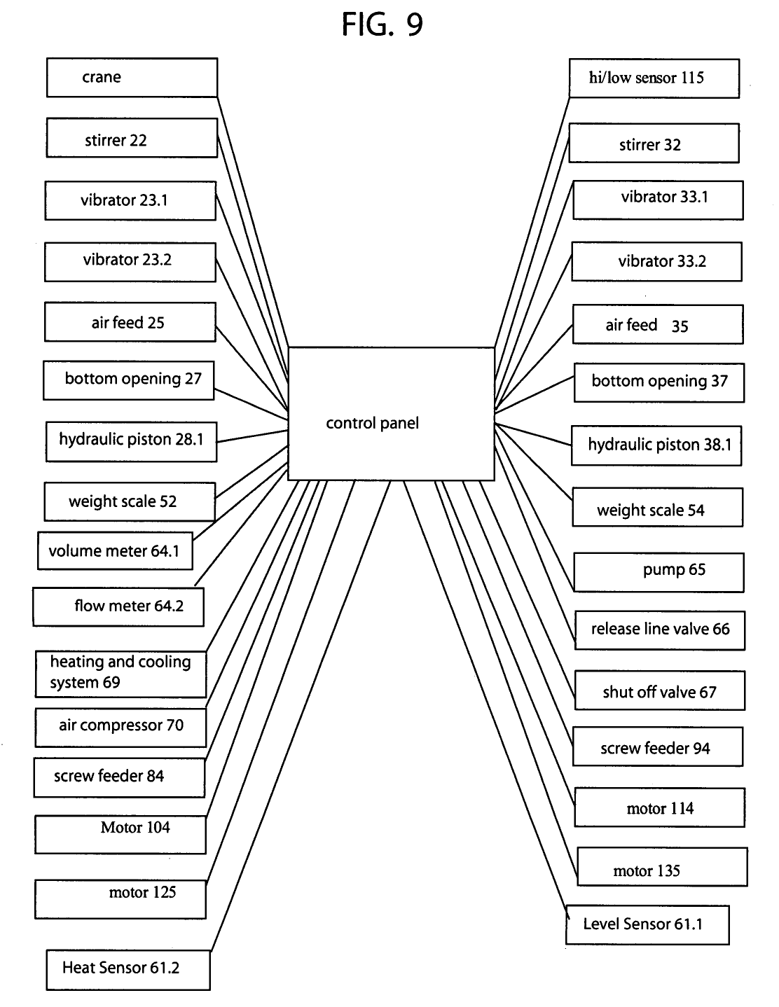

FIG. 9 discloses schematic block diagram of many of the components that can be controlled by control panel 40. For example as shown in this view, control panel 40 can be in communication with crane 11 as well as a plurality of components associated with silo 20. For example control panel 40 can be in communication with stirrer 22, vibrator 23.1, vibrator 23.2, air feed 25, bottom opening 27, hydraulic piston 28.1 and weight scale 52 which are all associated with binder silo 22. In addition, control panel 40 can also be in communication with, and control flowmeter 64.2, heating and cooling system 69, air compressor 70, screw feeder 84, motor 104, motor 125, and heat sensor 61.2.

In addition, control panel 40 can also be in communication with high-low sensor 115 as well as a plurality of components associated with silo 30 such as stirrer 32, vibrator 33.1, vibrator 33.2, air feed 35, bottom opening 37, hydraulic piston 38.1, and weight scale 54.

In addition, control panel can also be in communication with pump 65, released on valve 66, shutoff valve 67, screw feeder 94, motor 114, and motor 135, or level sensor 61.1.

All of these components can be in communication with control panel 40 in either a wireless or wired manner to communicate with control panel 40 such that these components can either be controlled by a program running on computer 42 in control panel 40 or simply report their status to control panel 40.

Control panel 40 shown in greater detail in FIG. 10. In this case, control panel 40 includes computer 42, which is coupled to a monitor 43. Computer 42 also has a keyboard 44 allows the user to enter data into computer 42 or to use the keyboard to control components in communication with control panel 40. There is also another control section 45 which includes dial switches and additional buttons for controlling different components in communication with control panel 40. In this case, computer 42 can be in the form of a standard personal computer which can run any useful operating system such as a Windows® type operating system, having a customized program for controlling the entire system, including controlling order and billing generation processes.

Computer 42 can be used to create reports which can then be printed on printer 46. In addition, there can also be a section for a series of dials and switches 45 which can be used to selectively control different components in the system.

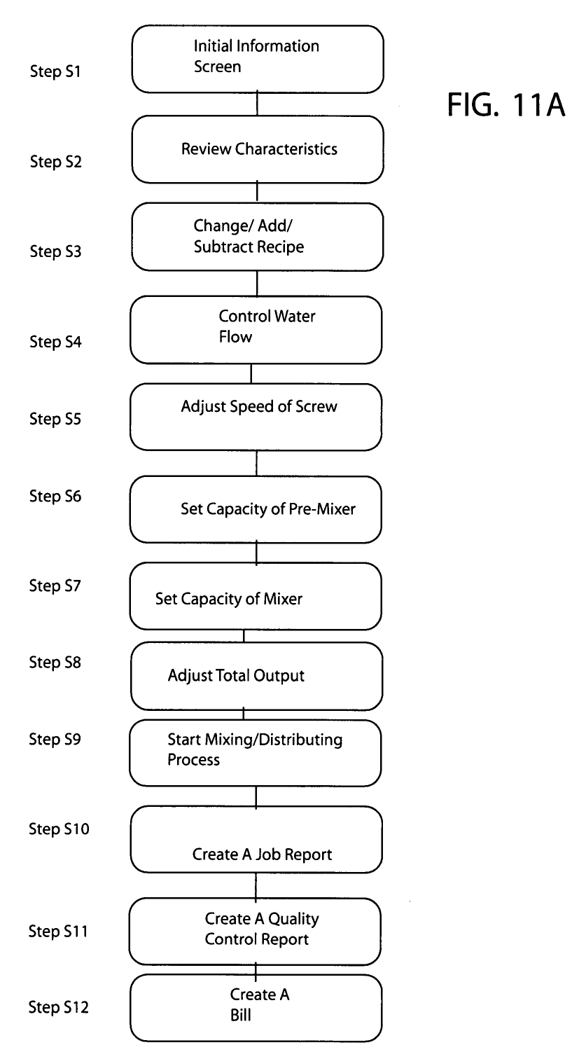

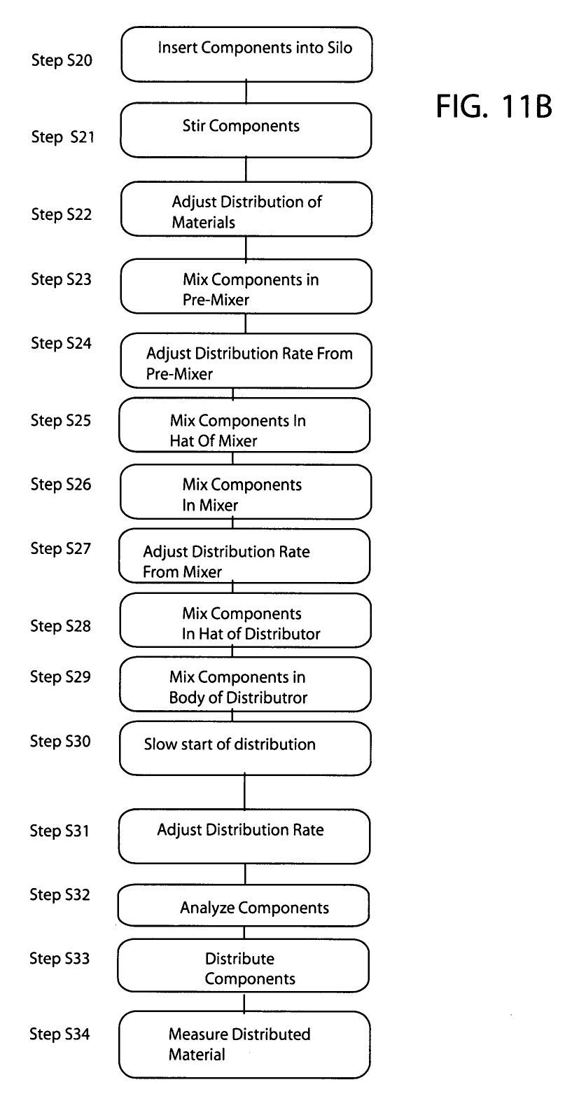

FIGS. 11A and 11B show the different processes that are controlled by a program running on computer 42 in control panel 40. For example, FIG. 11A discloses the basic controlling processes both before and after the material is mixed and distributed. FIG. 11B is a detailed explanation of step S9 shown in FIG. 11A, which shows the actual stages of mixing and delivering building components.

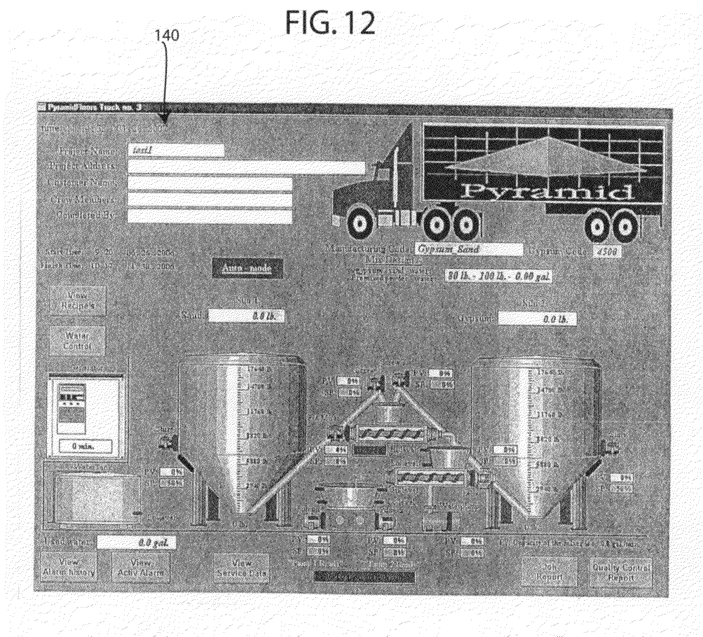

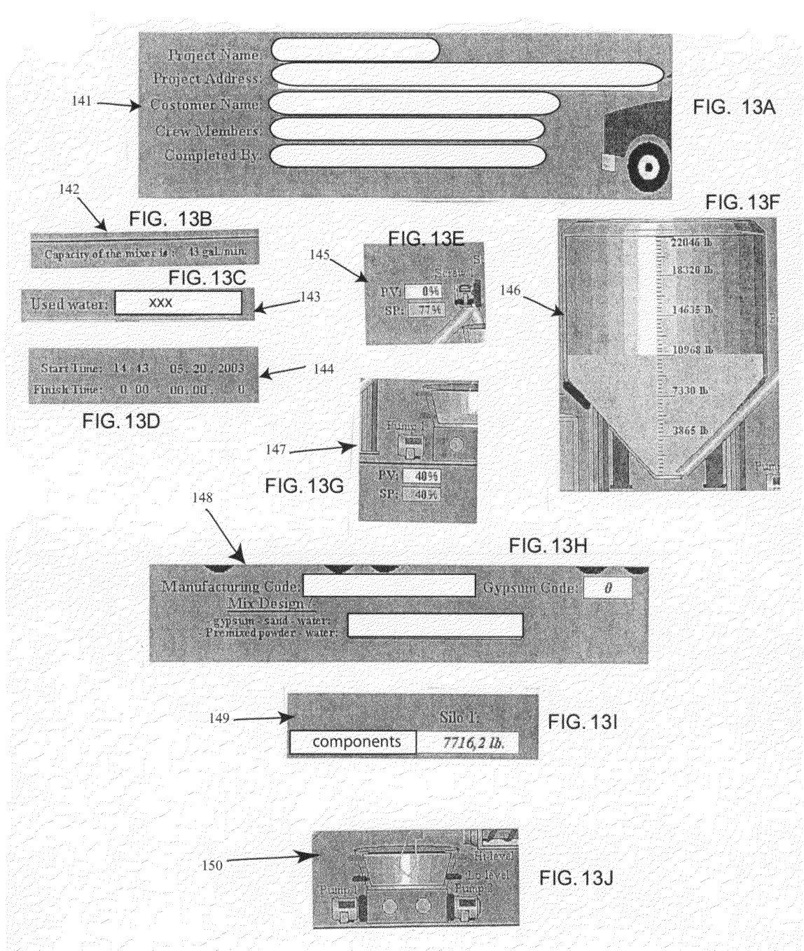

For example, as shown in FIG. 11A, when a user accesses control panel 40, that user can review an initial information in step S1 in FIG. 11A, wherein this information is shown in a graphical and textual screen 140 (See FIG. 12). Next, the user can review a plurality of characteristics as shown in FIG. 13 wherein these characteristics can include a login section 141 which lists the project name, the project address, the customer name, crew members, and the employee who completes the project. In addition, a plurality of other screens are also disclosed which allow the user to review particular characteristics. For example, there is a mixer capacity display section 142, a used water display section 143, a start and finish time display section 144, a silo capacity output display section 145, a capacity level display section 146, a pump output percentage display section 147, a mix output display section 148, a silo distribution weight display 149, and a high-low sensor display 150.

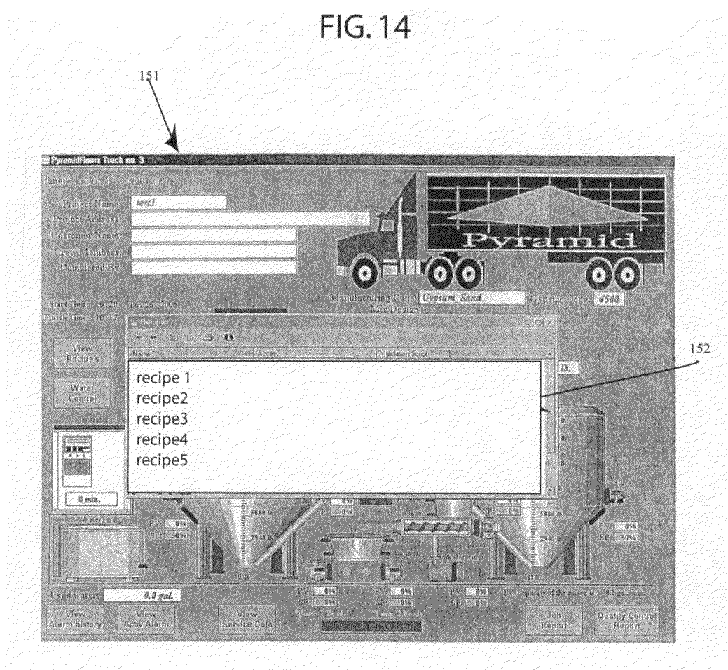

Next, in step S3, a user can review and input different characteristics of a mix such as the recipe. For example, as shown in FIG. 14, there is a screen listing for recipes 151 including a pulldown bar listing of preset recipes 152. In this case, a user can simply select a preset recipe and follow that exact recipe including a preset level of material being input into the system, the rate at which it is being input, mixing speeds, water amounts as well as distribution speeds.

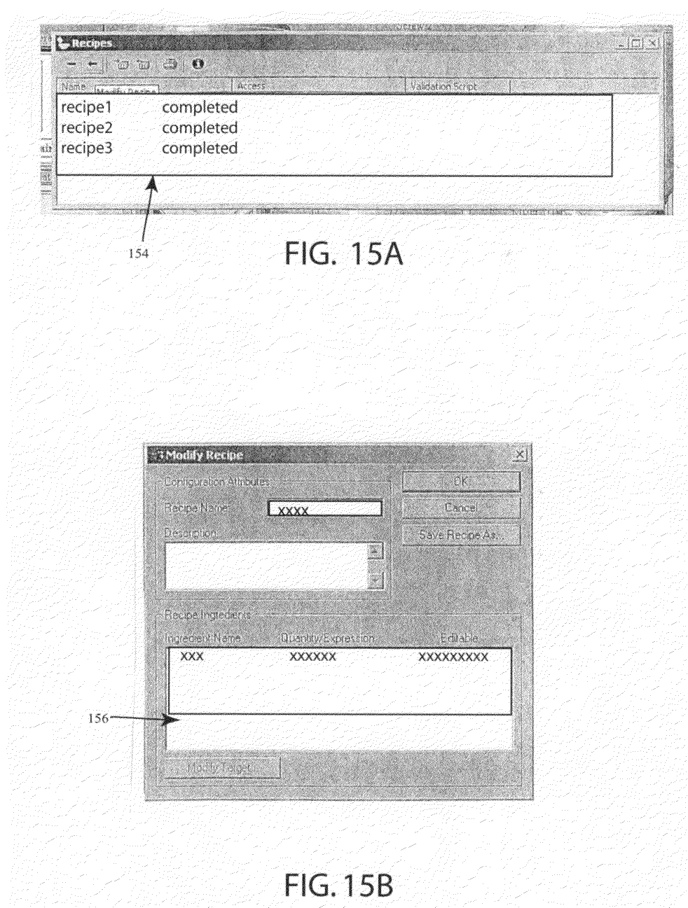

Alternatively, as shown in FIGS. 15A and 15B, the user could modify a recipe by selecting a particular recipe in screen 154 and then changing preset levels as shown in change or modify screen 156.

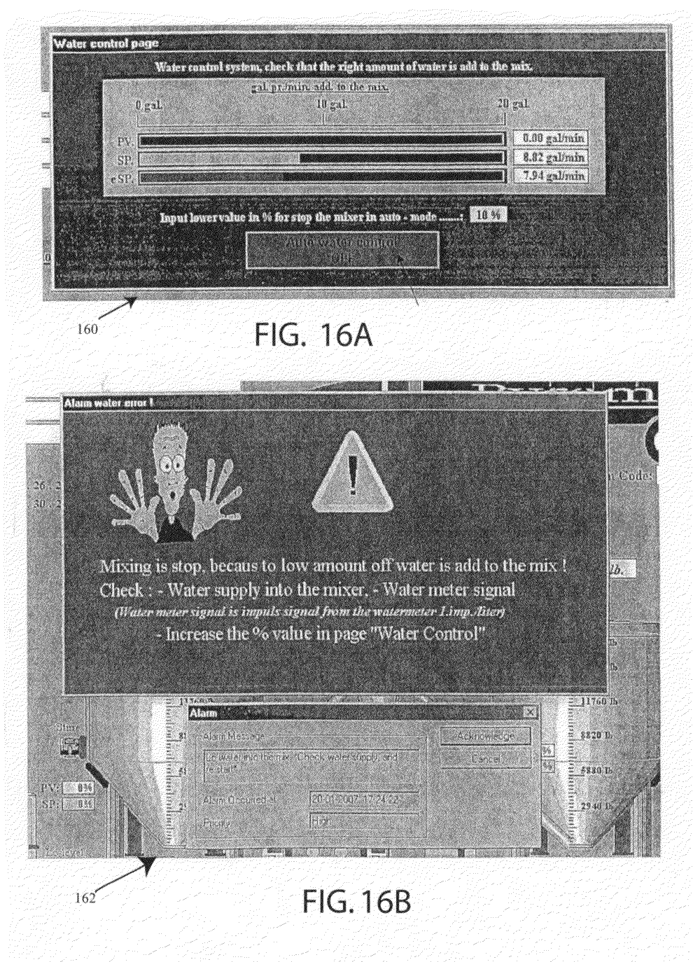

Upon setting the recipe, user could also in step S4, control flow of water. For example, FIG. 16A discloses a water control prompt 160 which allows the user to control the amount of water being input into the system. Plus, if the user wishes to increase or decrease the amount of water or the percentage of water in the mix, then the user can simply through control panel 40, reduce or increase the amount of water in the mix. If the program on control panel 40 determines that there is either an insufficient amount of water, or too much water added to the mix, then this program will prompt the user to change the percentage of water in the mix as shown in prompt screen 162 as shown in FIG. 16B.

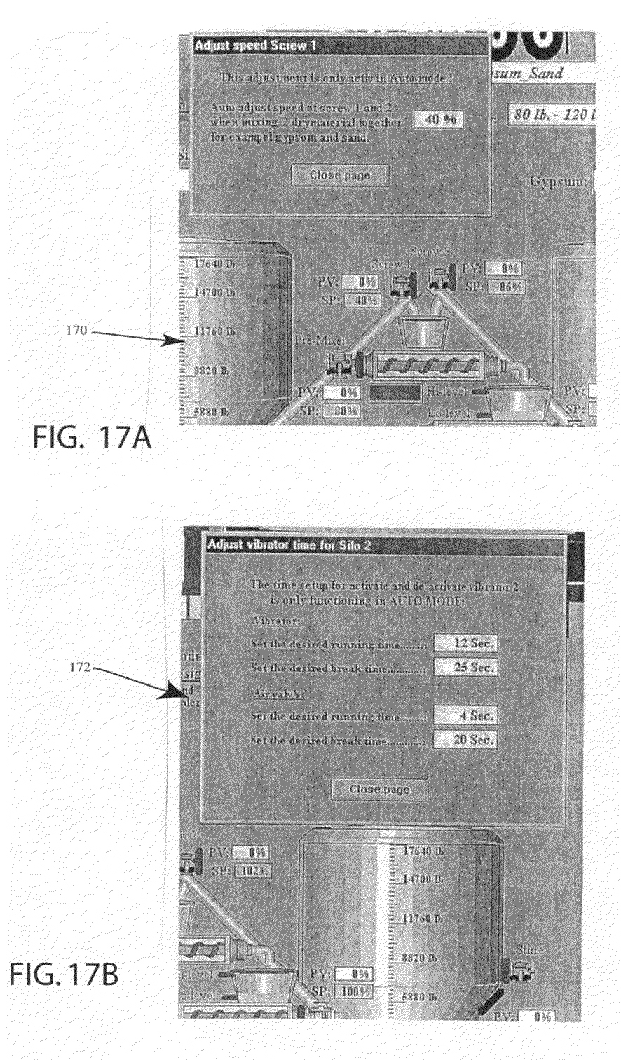

Step S5 allows the user to adjust the speed of the screw in either column 80 or 90. In this case, the user can adjust the speed screw as a percentage of its total possible speed. For example, if the user wishes to increase a certain amount of component, that user could adjust the speed of the screw which is disposed in either column 80 or 90 to either draw more or less out of silos 20 or 30 to adjust the amount of material in the mix. This adjustment can be achieved through prompt screen 170 (See FIG. 17A). In addition, the user can also control the amount of vibration in the silos. For example, prompt screen 172 (See FIG. 17B) allows the user to set the desired running time or break time for vibration in the silos. Furthermore, the user can also adjust the amount of an air input into the silos by setting the amount of desired running time of the amount of desired break time per interval. In this way, the mix in each of these silos is continuously stirred so that these components do not form aggregate rocks.

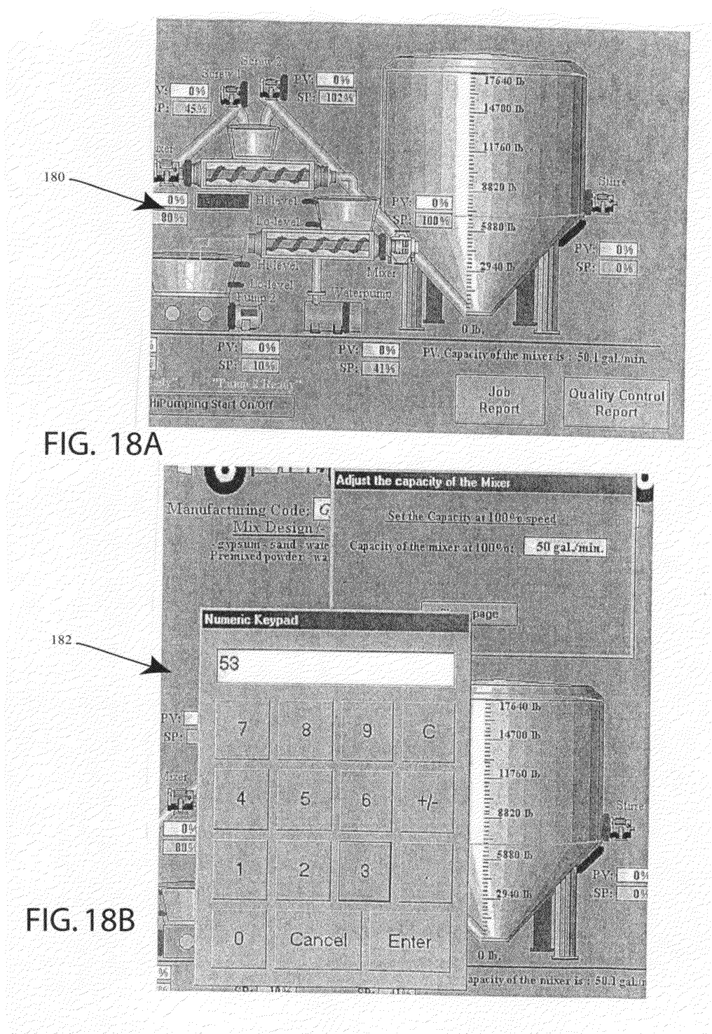

Next, in step S6, the user can set the capacity of a pre-mixer. In this case, the user can adjust the percentage level of the pre-mixer based on its potential output is shown in screen 180 (See FIG. 18A) and in screen 182 as shown in FIG. 18B. In addition, as shown in step S7, the user can also set the capacity of the mixer by adjusting the potential capacity as shown in screens 180 and 182 as well.

Next, in step S8, the user can adjust the total level of output which is output from each of the distribution elements or feeders 120 and 130 associated with each of screw feeders 127 and 137. For example, as shown in screens 180 and 182 (See FIG. 18A), a user can adjust the operating capacity of motors 125 and 135 which can be used to control the amount of output out of these output tubes.

Once all the parameters have been set, in step S9 the mixing process can start. This mixing process and distribution process is shown in greater detail in FIG. 11B.

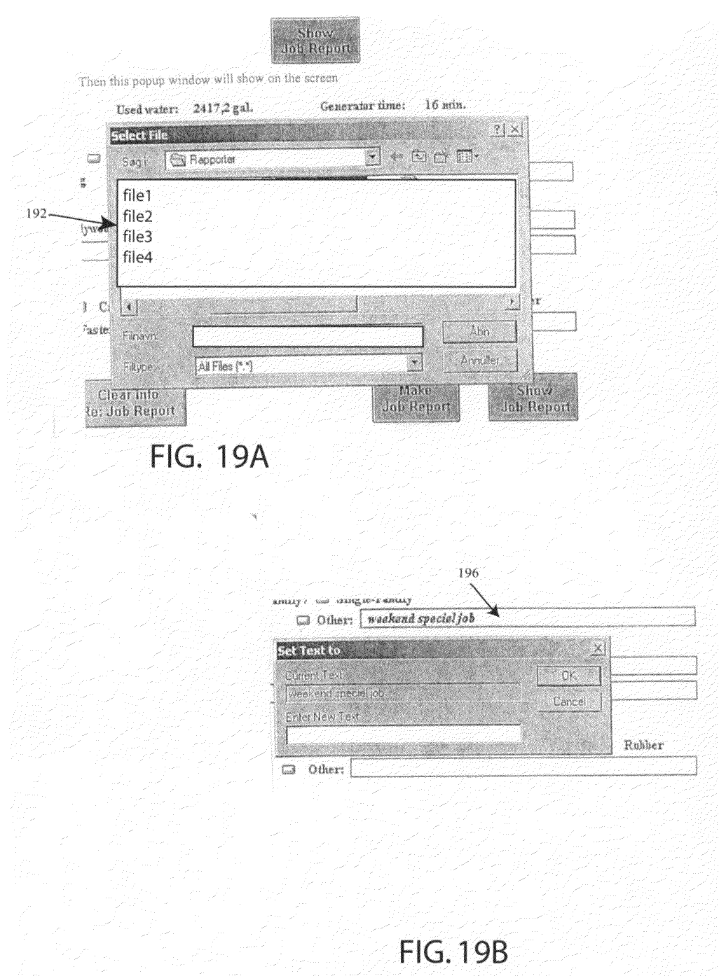

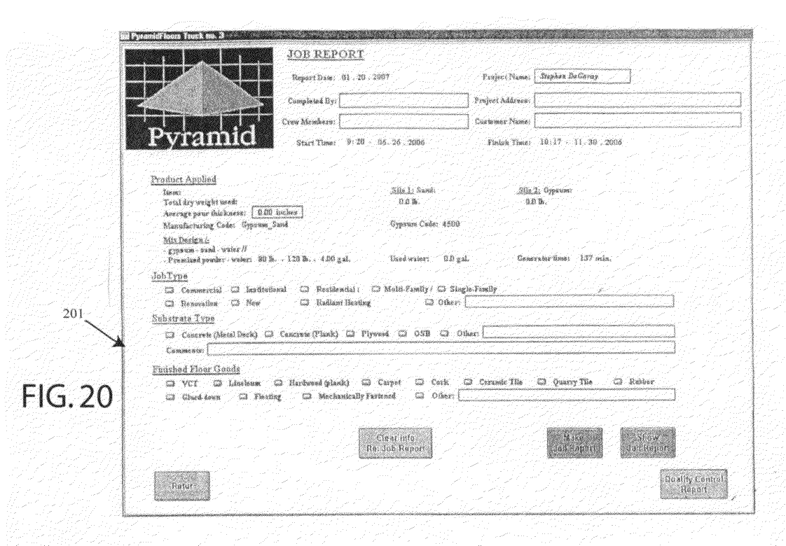

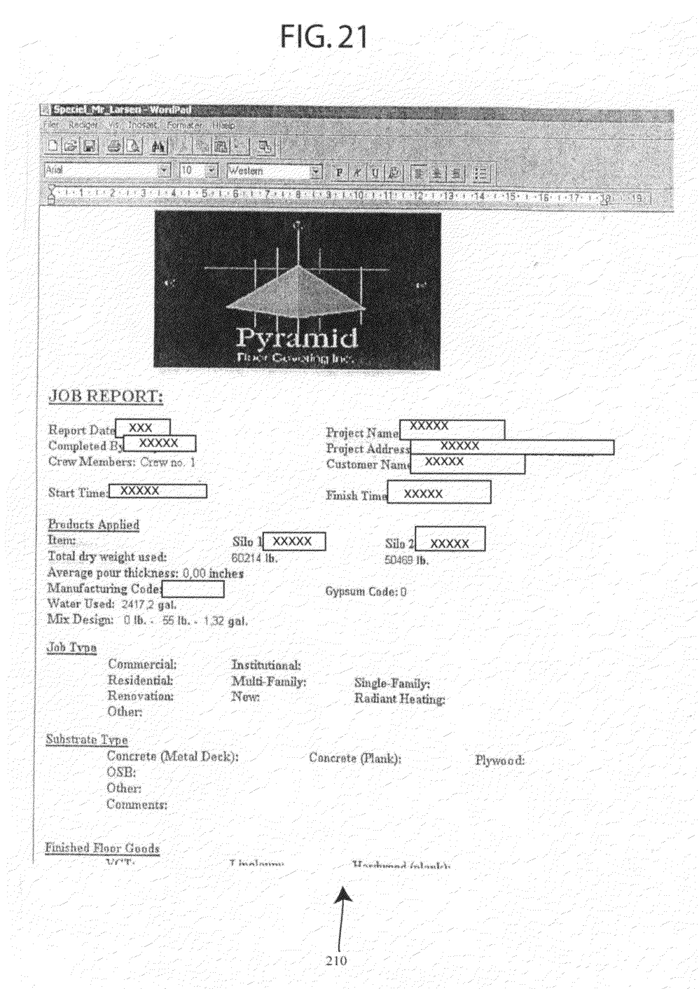

Once the process has been completed, in step S10 a user can create a job report. This job report can be customized wherein this customization is shown in greater detail in FIGS. 19A and 19B, which shows a job report selection screen 192, and a modified job report screen 196. The further modification of this job report can be shown in greater detail in FIG. 20 which discloses screen 201 which discloses a screen for modifying a job report. The screen allows the user to input different information into the job report to create customized job reports based on the data collected once all the material has been distributed. A screen showing the final job report is shown in FIG. 21 wherein screen 210 lists all the characteristics associated with this job including the clients, the crew team, start times, the amount of dry material distributed, and the amount of water used.

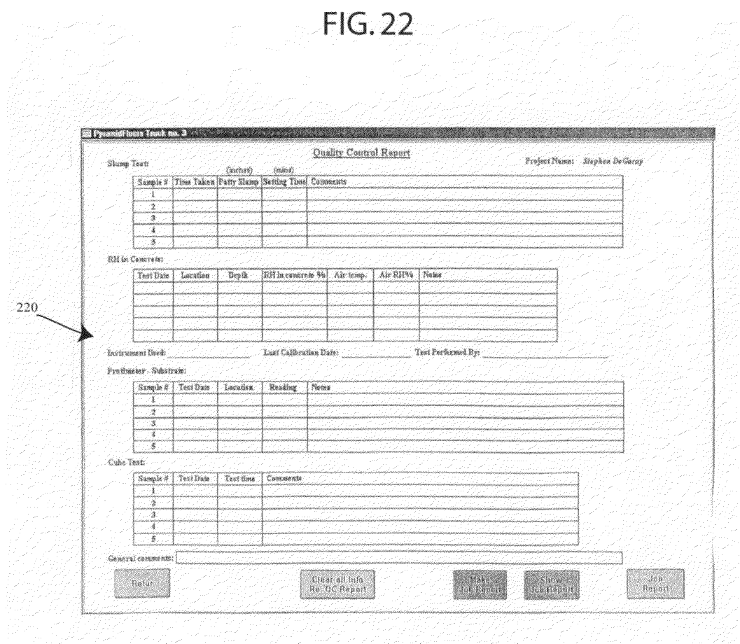

Next, step S11 involves the step of generating a quality control report. For example there is a quality control screen 220 shown in FIG. 22 which discloses a quality control report which is created based upon samples taken from solid blocks taken from a floor that was previously distributed. The creation of this quality control report results in a listing of these samples and their associated tested readings.

FIG. 11B is a flow chart for the process for distributing material on a job site. For example, step S20 includes inserting components into a silo such as silos 20 and 30. In this case, a crane 11 can be used to lift heavy bags of material from another location and cut this material open on either cutter 21 over silo 20 or open bags of material on cutter 31 over silo 30. The cutting of these bags causes the contents of these bags to flow through either screen 29 over silo 20 or through screen 39 over silo 30. Once each of these components have been inserted into the silo, a program in control panel 40 continuously monitors and updates the weight of material in these silos and reports on this weight in control panel 40. Next, in step S21, these materials are stirred. The stirring of these materials occurs via associated stirrers 22 or 32 associated vibrators 23.1, or 23.2 or 33.1 or 33.2, or through air stirring via associated air feeds 25 and 35. As stated above, these materials are continuously stirred so that they do not develop into aggregate components which may then clog feeding screws.

In step S22, the distribution of these materials can then be continuously adjusted by adjusting the distribution rate of screws in each of the columns. For example, the setting is similar to step S5 where this rate was pre-set. In this case, a user can now adjust the speed of screws turning and feeding material up through columns 80 and 90 after material has been entered into the silos. For this step to occur, material must be released and fed from each silo. For example, the bottom openings 27 and 37 allow this material to flow into respective columns 80.

In step S23, these different components are then mixed in a pre-mixer such as pre-mixer 100. The mixing of these components can occur through the use of a mixing elements such as mixing element 102. In this case, the user can also continuously adjust the distribution rate from the pre-mixer in step S24. For example, the adjustment of this distribution rate can occur by setting the capacity of pre-mixer 100 as shown in step S6. While step S6 can be set as a preset value, this step allows a user to adjust the rate while the mixing process is occurring as well.

Step S25 involves the mixing of components in hat 111 of mixer 110. For example, material that flows out from pre-mixer 100 next flows into hat 111 wherein this material is then mixed again before then flowing into mixer 110. Mixing inside of hat 111 occurs via mixing element 112 which can be in the form of a screw or angled paddle.

Step S26 involves mixing these components in mixer 110. The mixing of these components involves mixing all of the components that were mixed in pre-mixer 100, as well as mixing these components with the addition of water or other liquid solutions into the mix. The mixing of these components together via mixing element 113 creates a slurry component which can then be distributed into feeders or distribution elements 120 and 130.

Step S27 involves the adjustment of the distribution rate from mixer 110. In this case, while the distribution rate of the mixer 110 has been preset in step S6 as in step S7, this preset value can be reset in step S27 to control the distribution rate from the mixer.

Step S28 involves mixing the components from mixer 110 in associated hats or settling bins 123, and 133. In this step, associated mixing elements 126 and 136 can be used to further mix these components in the settling bins 123 and 133 before allowing these components to further move into the body of these feeders. Once these components settle into the body of these feeders, in step S29, these components are still further mixed in the body of these feeders. Step S30 comprises a slow start of feeding screws 127 and 137 so that the threads or paddles related to these screws 127 and 137 do not break upon an initial start up.

Conversely, when these screws are shut down, associated magnetic brakes 129 and 139 which are associated with and coupled to motors 125 and 135 respectively can be used to prevent screws 127 and 137 from rotating backwards and creating a back filling event wherein material flows back inside these feeders and then spills out from the associated hats 123 and 133.

Next, in step S31 the user can continuously monitor or adjust the distribution rate of material flowing out from these feeders or distributors 120 and 132 to control the flow of material flowing out of the system. Through all the steps, the program running on control panel 40 continuously analyzes the processing of these components in step S32. Next, in step S33, components are then distributed in the form of a slurry which can then form building components such as walls and floors etc.

Finally, in step S34, these distributed materials can then be measured. For example, sets or blocks of components can be drawn from flooring material wherein these components can then be measured so that they are compared to a preset level for quality control. The values associated with these components can then be inserted into a quality control report such as disclosed in step S11.

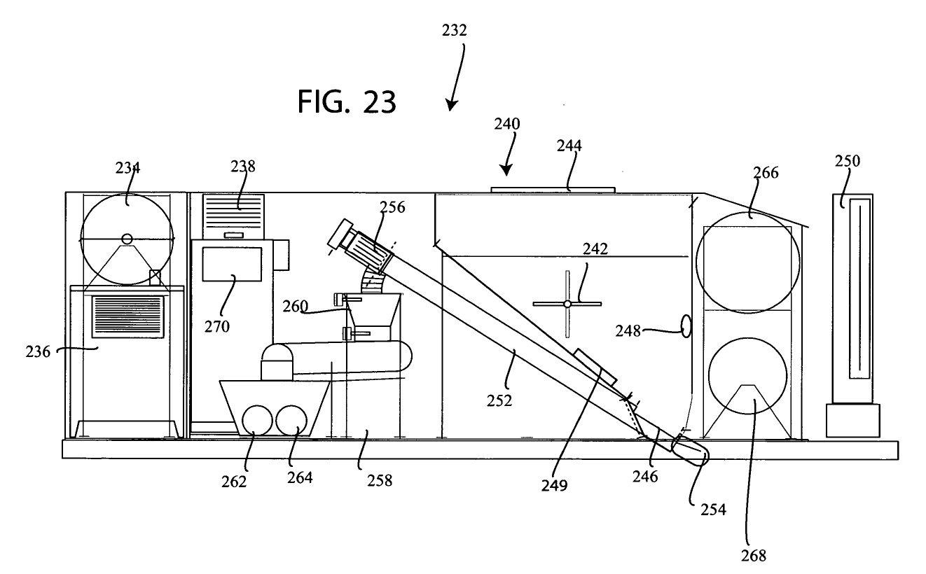

FIG. 23 is a side view of a single silo truck 232. In this case, single silo truck 232 includes a hose wheel 234, and a generator 236 for generating power for the different driven components. Disposed adjacent to generator 236 is a cooling unit 238 for cooling the water or other liquids being input into the system. In this case, there is a single silo 240 having a hatch 244 covering an opening in this silo. Disposed inside silo 240 is a stirrer 242 for stirring a preset mixture which in many cases can be sand and a binder material. Other components for stirring this mixture can also be included such as vibration elements 249 which are similar to the vibration elements shown in FIGS. 5A and 5B, and an air input 248 for inputting air into silo 240.

A crane 250 can be used to input bags of material into silo 240 via the opening in hatch 244. Silo 240 also has an output 246, which allows the mixed and stirred material to be dispensed from silo 240 and into column 252.

Material is fed up through column 252 via a screw 255, which is driven by motor 254. Motor 254, stirrer 242, hatch 244, and air input 248 in this silo are all controlled by a central computer 270. This mixed material is then fed up through column 252 and then dropped via a gravity feed through hole or output 256 into hat 258. Once the material is dropped into hat 258, it is stirred and then dropped into mixer 260. Mixer 260 is similar to mixer 110 and has a fluid input that adds additional fluid such as water to the mixture. The addition of water to this mixture creates a slurry which can then be input into hats for each respective distributor or feeder 262 or 264 which can be the same or similar to feeders 120 and 130 shown in FIGS. 7A and 7B.

In addition, a water tank 266 can be used to input water into this mixer 260 wherein this water can be fed through a water distribution system such as that shown in FIG. 8. Furthermore, there is an air pump 268 which can be used to supply relatively high pressure air to the air input 248 to stir the mixed material. The process for setting up this system is similar to that shown in FIG. 11A, however, these steps do not include step S6 which is directed towards setting the capacity of a pre-mixer since this pre-mixer is not incorporated into these components. In addition, the process for creating the slurry and distributing the slurry with this embodiment is similar to that shown in FIG. 11B however this process does not include steps S23 and S24, because as stated above, this embodiment does not include a pre-mixer.

In addition, the system results and may easily handle system for both distributing materials as well as generating quality control reports as well as itemized job reports. In addition, because all of the distribution characteristics have been collected, this system can also track the amount of material that is distributed to create a good appropriate billing system.

Accordingly, while a few embodiments of the present invention have been shown and described, it is to be understood that many changes and modifications may be made thereunto without departing from the spirit and scope of the invention as defined in the appended claims.

What is claimed is:

1. A process for creating a flooring material comprising:
a) providing at least one building component distribution system on a flatbed of a motor vehicle;
b) moving said motor vehicle to a job site;
c) stirring a first set of components in a silo;
c) stirring a second set of components in a silo;
d) mixing said first set of components with said second set of components to create a dry mixture;
e) mixing said dry mixture with a liquid to create a slurry mixture;
f) monitoring said mixing;
g) distributing said slurry mixture to create a building component; and
h) locking said distribution to prevent backflow of components.

2. The process as in claim 1, wherein said step of providing said building component distribution system comprises providing a system with at least one silo.

3. The process as in claim 1, wherein said step of stirring a first set of components in a silo comprises providing at least one of the following mixing components, a stirrer having paddles; a vibration stirrer; an air stirrer and a screw stirrer.

4. The process as in claim 1, wherein said step of mixing said first set of components with said second set of components occurs in a container, wherein said first set of components is a binder material and said second set of components is sand.

5. The process as in claim 4, wherein said step of mixing said dry mixture with a liquid comprises mixing said dry mixture with water.

6. The process as in claim 1, further comprising the step of presenting a preset menu of recipes including a preset range of parameters for mixing said components.

7. The process as in claim 6, further comprising the step of presenting a user with an option to modify said recipes to create new parameters for mixing said components.

8. The process as in claim 1, further comprising the step of generating a job history report based upon the amount of slurry distributed.

9. The process as in claim 1, further comprising the step of generating a quality control report based upon tests taken from samples of said slurry.

10. The process as in claim 1, further comprising the step of automatically generating a bill based upon an amount of slurry that is deposited.

11. The process as in claim 1, wherein said step of automatically generating a bill includes monitoring an amount of material that is deposited and then calculating a total amount for billing based upon the amount of material deposited.

12. A portable system for distributing building materials comprising:
a) a motor vehicle;
b) at least one container coupled to said motor vehicle;
c) at least one stirrer disposed in said at least one container, said at least one stirrer for stirring a first component in said container;
d) at least one mixer coupled to said motor vehicle said mixer for mixing at least one liquid component with said at least one component in said container to form a slurry;
e) at least one distribution feeder for feeding said slurry to a work site;
f) at least one lock for selectively locking said at least one distribution feeder;
g) at least one computer for controlling said at least one mixer, said at least one distribution feeder, and said at least one lock.

13. The system as in claim 12, wherein said motor vehicle is in the form of a truck.

14. The system as in claim 12, further comprising at least one additional container, wherein said at least one container is for holding a binder and said at least one additional container is for holding sand.

15. The system as in claim 14, further comprising at least one pre-mixer for mixing said binder and said sand together.

16. The system as in claim 15, further comprising:
a first container feeder coupled to said at least one container for feeding material from said at least one container into said pre-mixer,
a second container feeder coupled for feeding material from said at least one additional container into said pre-mixer; and
a pre-mixer feeder coupled to said pre-mixer for feeding said mixture from said pre-mixer; and
a mixer feeder coupled to said mixer, said mixer feeder for feeding said slurry from said mixer to said at least one distribution feeder.

17. The device as in claim 16, wherein said at least one distribution feeder comprises at least two distribution feeders.

18. The device as in claim 17, wherein said computer is for controlling a feeding rate of said first container feeder, said second container feeder, said pre-mixer feeder, and said mixer feeder.
